(19) United States
(12) Patent Application Publication
(10) Pub. No.: US 2023/0034003 A1
(43) Pub. Date: Feb. 2, 2023

(54) RADIO COMMUNICATION NODE

(71) Applicant: NTT DOCOMO, INC., Tokyo (JP)

(72) Inventors: Daisuke Kurita, Tokyo (JP); Hiroki Harada, Tokyo (JP); Weiqi Sun, Beijing (CN); Jing Wang, Beijing (CN); Xiaolin Hou, Beijing (CN)

(73) Assignee: NTT DOCOMO, INC., Tokyo (JP)

(21) Appl. No.: 17/756,517

(22) PCT Filed: Nov. 28, 2019
(86) PCT No.: PCT/JP2019/046622

§ 371 Date: May 26, 2022

(51) Int. Cl. H04W 56/00

(52) U.S. Cl. CPC H04W 56/001

(57) ABSTRACT

When a transmission timing of a downlink and a reception timing of an uplink at a radio communication node 100B are aligned, a radio communication node 100A determines an alignment value of the reception timing based on timing information used to determine transmission timing of the uplink, or an offset value from the timing information. The radio communication node 100A transmits the determined alignment value or offset value to the radio communication node 100B.

### TECHNICAL FIELD

The present invention relates to a radio communication node that configures radio access and radio backhaul.

### BACKGROUND ART

The 3rd Generation Partnership Project (3GPP) specifies Long Term Evolution (LTE) and specifies LTE-Advanced (hereinafter referred to as LTE including LTE-Advanced) and post-LTE systems called 5G New Radio (NR) or Next Generation (NG) for the purpose of further increasing the speed of LTE.

For example, in a radio access network (RAN) of NR, integrated access and backhaul (IAB) in which radio access to a terminal (User Equipment, UE) and radio backhaul between radio communication nodes such as radio base stations (gNB) are integrated is being discussed (see Non Patent Literature 1).

In the IAB, an IAB node has a Mobile Termination (MT) that is a function for connecting to a parent node (which may also be called an IAB donor) and a Distributed Unit (DU) that is a function for connecting to a child node or a UE.

In 3GPP Release 16, radio access and radio backhaul are based on half-duplex and time division multiplexing (TDM). Also, in Release 17 and later, application of space division multiplexing (SDM) and frequency division multiplexing (FDM) is being discussed.

In Non Patent Literature 1, seven cases are specified regarding the alignment of transmission timing between a parent node and an IAB node. For example, as a premise, alignment of downlink (DL) transmission timing between an IAB node and an IAB donor (Case #1), alignment of DL and uplink (UL) reception timings at an IAB node (Case #3), and combination of alignment of DL transmission timing of Case #1 and UL reception timing of Case #3 (Case #7) are specified.

In Case #1, in order to match the DL transmission timing at the DU of each node, it is agreed that the IAB node uses a calculating formula (TA/2+T_delta) to calculate propagation delay (T_{propagation_0}) of path (0) with the parent node and transmit the transmission timing as offset.

Here, TA is a value of Timing Advance for determining the transmission timing of the UE specified in 3GPP Release 15, and T_delta is determined considering the switching time from reception to transmission of the parent node.

### CITATION LIST

### Non Patent Literature

Non Patent Literature 1: 3GPP TR 38.874 V16.0.0, 3rd Generation Partnership Project; Technical Specification Group Radio Access Network; NR; Study on Integrated Access and Backhaul; (Release 16), 3GPP, December 2018

### SUMMARY OF INVENTION

As described above, in Case #7, it is necessary to realize not only alignment of DL transmission timing of Case #1, specifically, an IAB node and an IAB donor DU, but also alignment of Case #3, specifically, DL and UL reception timings at an IAB node.

That is, in the case of supporting Case #7, it is necessary to match the DL and UL reception timings of an IAB node in addition to the DL transmission timing between a gNB and an IAB node.

Therefore, the present invention has been made in view of such circumstances, and an object of the present invention is to provide a radio communication node capable of reliably matching transmission timing and reception timing of a Distributed Unit (DU) and a Mobile Termination (MT) in an Integrated Access and Backhaul (IAB).

According to one aspect of the present disclosure, a radio communication node (for example, a radio communication node 100A) includes: a control unit (control unit 140) configured to, when a transmission timing of a downlink and a reception timing of an uplink at a lower node (for example, a radio communication node 100B) are aligned, determine an alignment value of the reception timing based on timing information (TA) used to determine transmission timing of the uplink, or an offset value from the timing information; and a transmitting unit (for example, a timing related information transmitting unit 150) configured to transmit the alignment value or the offset value to the lower node.

According to one aspect of the present disclosure, a radio communication node (for example, a radio communication node 100B) includes: a control unit (control unit 170) configured to, when a transmission timing of a downlink and a reception timing of an uplink at the radio communication node are aligned, determine an aligning method of the transmission timing of the downlink and the reception timing of the uplink, based on downlink control information from an upper node, or the transmission timing of the downlink and the reception timing of the uplink; and a transceiving unit (for example, a radio transmitting unit 161 and a radio receiving unit 162) configured to receive the uplink from a lower node and transmit the downlink to the lower node, based on the determined aligning method.

### BRIEF DESCRIPTION OF DRAWINGS

FIG. 1 is an overall schematic configuration diagram of a radio communication system 10.

FIG. 2 is a diagram illustrating a basic configuration example of an IAB.

FIG. 3 is a functional block configuration diagram of a radio communication node 100A.

FIG. 4 is a functional block configuration diagram of a radio communication node 100B.

FIG. 5 is a diagram illustrating an example of a relationship of T_{propagation_0}, TA, and T_delta.

FIG. 6 is a diagram illustrating an example of symbol-level timing alignment at a parent node and an IAB node in Case #7.

FIG. 7 is a diagram illustrating an example of slot-level timing alignment at a parent node and an IAB node in Case #7.

FIG. 8 is a diagram illustrating an example of slot-level timing alignment (including Tp and T1) at a parent node in Case #7.

FIG. 9 is a diagram illustrating a configuration example of Random Access Response (PAR) and MAC-CE.

FIG. 10 is a diagram illustrating an example of timing alignment at a parent node and an IAB node according to 3GPP Release-15 (Legacy), Case #6, and Case #7.

FIG. 11 is a diagram illustrating an example of a hardware configuration of a CU 50 and radio communication nodes 100A to 100C.

### DESCRIPTION OF EMBODIMENTS

Hereinafter, embodiments will be described with reference to the drawings. It should be noted that the same functions or configurations are denoted by the same or similar reference numerals, and a description thereof will be omitted as appropriate.

### (1) Overall Schematic Configuration of Radio Communication System

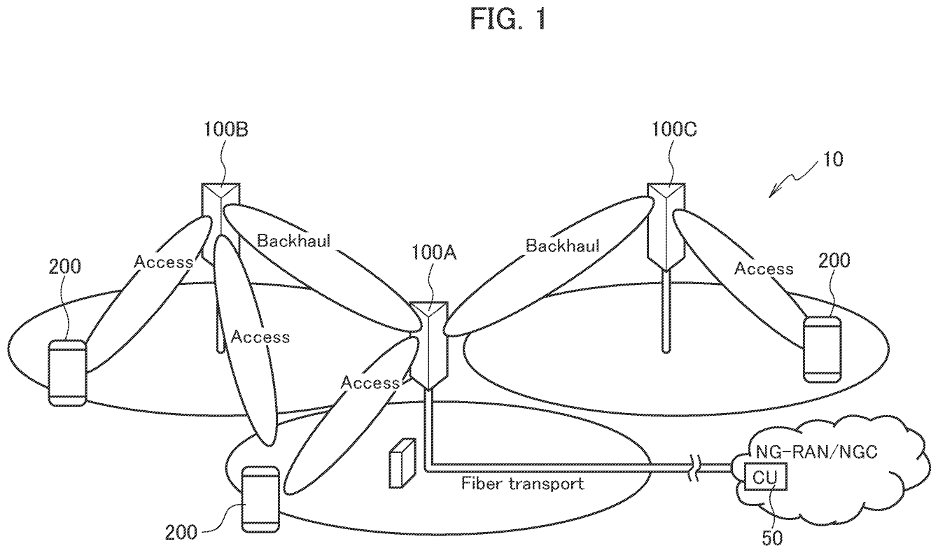

FIG. 1 is an overall schematic configuration diagram of a radio communication system 10 according to the present embodiment. The radio communication system 10 is a radio communication system in accordance with 5G New Radio (NR) and includes a plurality of radio communication nodes and a terminal.

Specifically, the radio communication system 10 includes radio communication nodes 100A, 100B, and 100C and a terminal 200 (hereinafter UE 200, User Equipment).

The radio communication nodes 100A, 100B, and 100C can configure radio access with the UE 200 and radio backhaul (BH) between the radio communication nodes. Specifically, a backhaul (transmission path) is configured by a radio link between the radio communication node 100A and the radio communication node 100B and between the radio communication node 100A and the radio communication node 100C.

As such, the configuration in which the radio access with the UE 200 and the radio backhaul between the radio communication nodes are integrated is referred to as Integrated Access and Backhaul (LAB).

The IAB reuses existing functions and interfaces defined for radio access. In particular, Mobile-Termination (MT), gNB-DU (Distributed Unit), gNB-CU (Central Unit), User Plane Function (UPF), Access and Mobility Management Function (AMF) and Session Management Function (SMF), and corresponding interfaces, for example, NR Uu (between MT and gNB/DU), F1, NG, X2 and N4, are used as base line.

The radio communication node 100A is connected with an NR radio access network (NG-RAN) and a core network (Next Generation Core (NGC) or 5GC) via a wired transmission path such as a fiber transport. The NG-RAN/NGC includes a Central Unit 50 (hereinafter CU 50) that is a communication node. It should be noted that the NG-RAN and the NGC may be simply referred to as “network”.

It should be noted that the CU 50 may be constituted by any one of UPF, AMF, and SMF described above, or a combination thereof. Alternatively, the CU 50 may be a gNB-CU as described above.

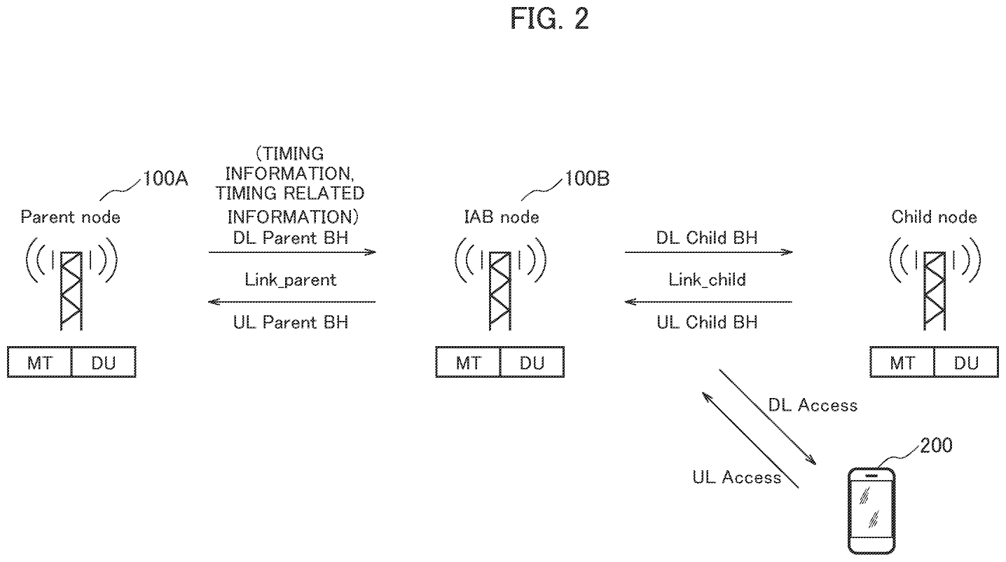

FIG. 2 is a diagram illustrating a basic configuration example of an IAB. As illustrated in FIG. 2, in the present embodiment, the radio communication node 100A constitutes a parent node in the IAB, and the radio communication node 100B (and the radio communication node 100C) constitutes an IAB node in the IAB. It should be noted that the parent node may be called an IAB donor.

A child node in the IAB is constituted by another radio communication node not illustrated in FIG. 1.

Alternatively, the UE 200 may constitute the child node.

The radio link is configured between the parent node and the IAB node. Specifically, the radio link called Link_parent is configured.

The radio link is configured between the IAB node and the child node. Specifically, the radio link called Link_child is configured.

The radio link configured between such radio communication nodes is called a radio backhaul link. Link_parent is constituted by a DL Parent BH in the downlink (DL) direction and a UL Parent BH in the uplink (UL) direction. Link_child is constituted by a DL Child BH in the DL direction and a UL Child BH in the UL direction.

That is, in the IAB, the direction from the parent node to the child node (including the UE 200) is the DL direction, and the direction from the child node to the parent node is the UL direction.

It should be noted that the radio link configured between the UE 200 and the IAB node or the parent node is called a radio access link. Specifically, the radio link is constituted by DL Access in the DL direction and UL Access in the UL direction.

The IAB node has a Mobile Termination (MT) that is the function for connecting to the parent node and a Distributed Unit (DU) that is the function for connecting to the child node (or the UE 200). It should be noted that the child node may be called a lower node.

Similarly, the parent node has an MT for connecting to an upper node and a DU for connecting to a lower node such as an IAB node. It should be noted that the parent node may have a CU (Central Unit) instead of the MT.

Also, similarly to the IAB node and the parent node, the child node also has an MT for connecting to the upper node such as the IAB node and a DU for connecting to the lower node such as the UE 200.

In the radio resources used by the DU, from the viewpoint of the DU, DL, UL and flexible time-resources (D/U/F) are classified into any type of hard, soft, or not available (H/S/NA). Also, even in the soft (S), available or not available is specified.

It should be noted that the configuration example of the IAB illustrated in FIG. 2 uses CU/DU division, but the configuration of the IAB is not necessarily limited thereto. For example, in the radio backhaul, the IAB is constituted by tunneling using GPRS Tunneling Protocol (GTP)-U/User Datagram Protocol (UDP)/Internet Protocol (IP).

The main advantage of such an IAB is that NR cells can be flexibly and densely arranged without densifying a transport network. The IAB can be applied to various scenarios such as outdoor small cell arrangement, indoors, and support of even mobile relay (for example, buses and trains).

Also, as illustrated in FIGS. 1 and 2, the IAB may also support NR-only standalone (SA) deployment, or non-standalone (NSA) deployment that include other RATs (such as LTE).

In the present embodiment, the radio access and the radio backhaul operate based on half-duplex. However, the radio access and the radio backhaul are not necessarily limited to half-duplex, and full-duplex may also be used as long as the requirements are satisfied.

Also, as the multiplexing scheme, time division multiplexing (TDM), space division multiplexing (SDM), and frequency division multiplexing (FDM) can be used.

When the IAB node operates in half-duplex, the DL Parent BH is the receiving (RX) side, the UL Parent BH is the transmitting (TX) side, the DL Child BH is the transmitting (TX) side, and the UL Child BH is the receiving (RX) side. Also, in the case of Time Division Duplex (TDD), the DL/UL configuration pattern at the IAB node is not limited to DL-F-UL, and the configuration pattern such as UL-F-DL is applied only to the radio backhaul (BH).

Also, in the present embodiment, the simultaneous operation of the DU and MT of the IAB node is realized by using SDM/FDM.

### (2) Functional Block Configuration of Radio Communication System

Next, the functional block configurations of the radio communication node 100A and the radio communication node 100B that constitute the radio communication system 10 will be described.

### (2.1) Radio Communication Node 100A

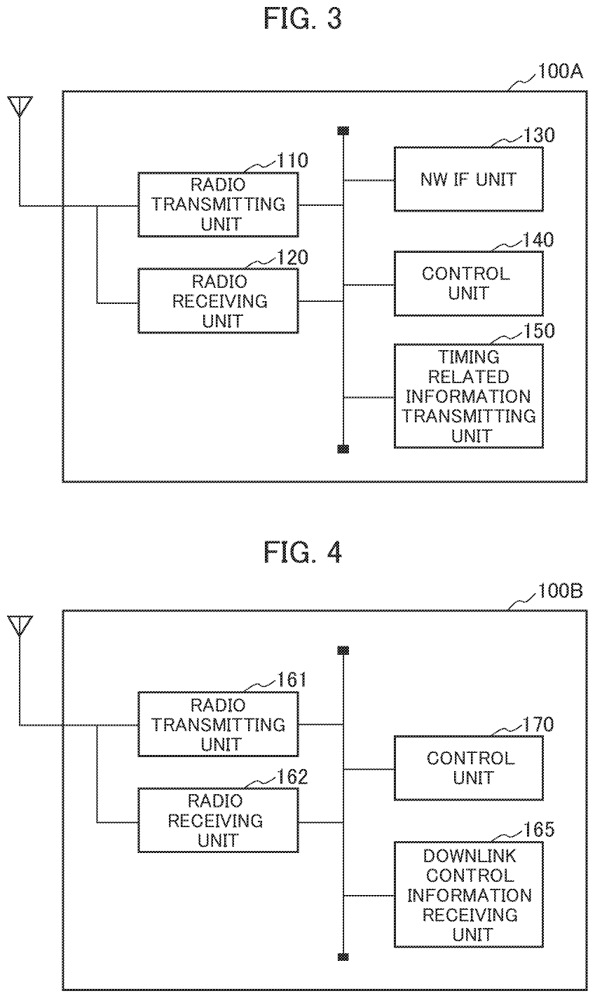

FIG. 3 is a functional block configuration diagram of the radio communication node 100A that constitutes the parent node. As illustrated in FIG. 3, the radio communication node 100A includes a radio transmitting unit 110, a radio receiving unit 120, an NW IF unit 130, a control unit 140, and a timing related information transmitting unit 150.

The radio transmitting unit 110 transmits a radio signal in accordance with the 5G specifications. Also, the radio receiving unit 120 transmits a radio signal in accordance with the 5G specifications. In the present embodiment, the radio transmitting unit 110 and the radio receiving unit 120 perform radio communication with the radio communication node 100B that constitutes the IAB node.

In the present embodiment, the radio communication node 100A has the functions of the MT and the DU, and the radio transmitting unit 110 and the radio receiving unit 120 also transmit and receive radio signals corresponding to the MT/DU.

The NW IF unit 130 provides a communication interface that realizes a connection with the NGC side or the like. For example, the NW IF unit 130 may include interfaces such as X2, Xn, N2, and N3.

The control unit 140 performs control of each functional block that constitutes the radio communication node 100A. In particular, in the present embodiment, the control unit 140 controls the DL and UL transmission timings and the UL reception timing. Specifically, the control unit 140 can align the DL transmission timing and the UL transmission timing at the lower node, for example, the radio communication node 100B (LAB node). Also, the control unit 140 can align the UL reception timing at the radio communication node 100B (LAB node).

That the control unit 140 aligns the DL transmission timing of each radio communication node including the radio communication node 100A may correspond to Case #1 specified in 3GPP TR 38.874, as described below.

Also, the alignment of the DL and UL transmission timings at the IAB node may correspond to Case #2. Furthermore, the alignment of the DL and UL reception timings at the IAB node may correspond to Case #3.

It should be noted that the alignment at the IAB node may include the alignment of the DL transmission timing at the IAB node, and the DL and UL transmission timings may be aligned at the IAB node.

That is, the control unit 140 can support Case #6 that is a combination of alignments of the DL transmission timing of Case #1 and the UL transmission timing of Case #2.

Furthermore, the alignment at the IAB node may include the alignment of the DL transmission timing at the IAB node, and the DL and UL reception timings may be aligned at the IAB node.

That is, the control unit 140 can support Case #7 that is a combination of alignments of the DL transmission timing of Case #1 and the UL reception timing of Case #3.

The control unit 140 can obtain a propagation delay between the radio communication node 100A (parent node) and the radio communication node 100B (lower node).

Specifically, the control unit 140 calculates the propagation delay of the path (0) between the parent node and the lower node based on (Equation 1).

T_{propagation_0}=(TA/2+T_delta) (Equation 1)

TA is a value of Timing Advance (TA) for determining the transmission timing of the UE specified in 3GPP Release 15. Here, TA may be called timing information.

Also, T_delta is determined considering the switching time from reception to transmission of the parent node. The method of calculating T_{propagation_0} will be described below in more detail.

As described above, when the control unit 140 aligns the DL transmission timing and the UL transmission timing at the IAB node (which may be read as the case corresponding to Case #6), the control unit 140 may obtain the propagation delay between the radio communication node 100A (parent node) and the radio communication node 100B (lower node) used for determining the DL transmission timing, and the propagation delay between the radio communication node 100A and the radio communication node 100B used for determining the UL transmission timing at the radio communication node 100B.

It should be noted that the propagation delay may mean T_{propagation_0} or may mean TA/2 or TA. Also, the propagation delay may be called the transmission time, delay time, or simply delay, and may be called by other names as long as they indicate the time required for DL or UL transmission between the radio communication nodes constituting the IAB.

Also, when the control unit 140 aligns the DL transmission timing and the UL reception timing at the lower node (which may be read as the case corresponding to Case #7), the control unit 140 may determine the timing information used for determining the UL transmission timing, specifically, the alignment value of the reception timing based on the TA or the offset value from the timing information (TA).

Here, the alignment value of the reception timing based on the TA may be a value in which information (for example, 1 bit) indicating positive (+) or negative (−) is added to a TA value by a TA command in a Random Access Response (RAR). Also, the alignment value may be only information indicating negative or may be another value associated with being negative.

Alternatively, the TA value (NTA) may be an expanded value. Specifically, in 3GPP Release-15, NTA can take a value of 0, 1, 2, . . . , 3846, but the alignment value of the reception timing based on the TA may be a negative value obtained by subtraction from 3846 using the value of 3847 to 4095. It should be noted that, in the case of 3847 or later, it may be treated as an implicitly applied negative value without necessarily subtracting.

Also, the offset value from the timing information (TA) may indicate an offset (time) from the TA value specified in 3GPP Release 15 or the TA value in the case corresponding to Case #6 described above. It should be noted that the offset value may be a value based on the TA or may not be a value based on the TA as long as the offset time can be determined.

The timing related information transmitting unit 150 transmits, to the lower node, information about the DL or UL transmission timing or reception timing (which may also be called timing related information). Specifically, the timing related information transmitting unit 150 can transmit information about the DL or UL transmission timing or reception timing to the IAB node and/or the child node.

Also, the timing related information transmitting unit 150 can transmit, to the lower node, the alignment value of the reception timing based on the TA described above or the offset value from the TA.

The timing information (TA) can be transmitted by using a TA command in a Random Access Response (RAR) or a Medium Access Control-Control Element (MAC-CE). Similarly, the information indicating that the DL transmission timing and the UL transmission timing or reception timing at the IAB node are aligned and the timing related information indicating the alignment value and the offset value described above may also be transmitted by using the MAC-CE, but may be transmitted by using signaling of an appropriate channel or an upper layer (such as radio resource control layer (RRC)).

Also, the timing information and the timing related information may also be transmitted by using signaling of an appropriate channel or an upper layer.

The channel includes a control channel and a data channel. The control channel includes a Physical Downlink Control Channel (PDCCH), a Physical Uplink Control Channel (PUCCH), a Physical Random Access Channel (PRACH), and a Physical Broadcast Channel (PBCH).

Also, the data channel includes a Physical Downlink Shared Channel (PDSCH) and a Physical Uplink Shared Channel (PUSCH).

It should be noted that a reference signal includes a Demodulation Reference Signal (DMRS), a Sounding Reference Signal (SRS), a Phase Tracking Reference Signal (PTRS), and a Channel State Information-Reference Signal (CSI-RS), and the signal includes the channel and the reference signal. Also, the data may mean data transmitted via the data channel.

UCI is control information that is symmetrical with Downlink Control Information (DCI), and is transmitted via a PUCCH or a PUSCH. UCI may include a Scheduling Request (SR), a Hybrid Automatic Repeat Request (HARQ) ACK/NACK, and a Channel Quality Indicator (CQI).

### (2.1) Radio Communication Node 100B

FIG. 4 is a functional block configuration diagram of the radio communication node 100B that constitutes the IAB node. As illustrated in FIG. 4, the radio communication node 100B includes a radio transmitting unit 161, a radio receiving unit 162, a downlink control information receiving unit 165, and a control unit 170.

The radio transmitting unit 161 transmits a radio signal in accordance with the 5G specifications. Also, the radio receiving unit 162 transmits a radio signal in accordance with the 5G specifications. In the present embodiment, the radio transmitting unit 161 and the radio receiving unit 162 perform radio communication with the radio communication node 100A constituting the parent node and radio communication with the child node (including the case of the UE 200).

Also, the radio transmitting unit 161 and the radio receiving unit 162 receive UL from the lower node and transmit DL to the lower node, based on the aligning method of the DL transmission timing and the UL reception timing determined by the control unit 170. In the present embodiment, the radio transmitting unit 161 and the radio receiving unit 162 constitute a transceiving unit.

The downlink control information receiving unit 165 receives downlink control information (DCI) from the upper node. Specifically, the downlink control information receiving unit 165 can receive DCI including information indicating the aligning method of the DL transmission timing and the UL reception timing.

More specifically, the downlink control information receiving unit 165 can receive DCI indicating which of Case #1, Case #6, and Case #7 is applied. That is, Case #1, Case #6, and Case #7 may be dynamically changed (switched) in the network.

The control unit 170 performs control of each functional block that constitutes the radio communication node 100B. In particular, in the present embodiment, the control unit 170 can align the DL transmission timing and the UL transmission timing and reception timing at the radio communication node 100B (lower node).

Specifically, when the control unit 170 aligns the DL transmission timing and the UL transmission timing at the radio communication node 100B (lower node), the control unit 170 matches the UL transmission timing with the DL transmission timing. That is, the control unit 170 uses the DL transmission timing as a reference to match the UL transmission timing with the DL transmission timing.

Also, when the control unit 170 aligns the DL transmission timing and the UL reception timing at the radio communication node 100B (which may be read as the case corresponding to Case #7), the control unit 170 may determine the aligning method of the DL transmission timing and the UL reception timing based on the downlink control information (DCI) from the upper node or the DL transmission timing and the UL reception timing.

Specifically, the control unit 170 may determine which of the aligning methods of Case #1, Case #6, and Case #7 is applied, based on the information included in the received DCI. Alternatively, the control unit 170 may implicitly determine which of the aligning methods of Case #1, Case #6, and Case #7 is applied, based on the DL transmission timing and the UL reception timing transmitted and received by the radio communication node 100B. It should be noted that the operation in which the radio communication node 100B (IAB node) implicitly determines which of the aligning methods of Case #1, Case #6, and Case #7 is applied will be described below.

Also, the control unit 170 may align the DL transmission timing at the upper node (for example, the radio communication node 100A) and the DL transmission timing at the radio communication node 100B, based on the time associated with the switching from UL reception to DL transmission, specifically, T_delta. It should be noted that, in this case, T_delta may be a value that is half the switching time from reception to transmission in the upper node (parent node). That is, the control unit 170 may align the DL transmission timing in consideration of the switching time from reception to transmission at the parent node.

Also, the alignment of the DL transmission timing may be performed by the radio communication node 100A.

### (3) Operation of Radio Communication System

Next, the operation of the radio communication system 10 will be described. Specifically, the operations associated with the alignments of the DL and UL transmission timings and reception timings in the radio communication system 10 will be described.

More specifically, the operation of aligning the DL and UL transmission timings in the IAB, which is used in the SDM and/or the FDM as the multiplexing scheme, especially the operation of aligning the DL and UL transmission timings when Case #6 specified in 3GPP TR 38.874 is applied will be described.

### (3.1) Specified Contents of 3GPP

First, the specified contents of the 3GPP will be briefly described. In 3GPP TR 38.874 (for example, V16.0.0), the following seven cases are specified in order to match the DL or UL transmission timing between the radio communication nodes constituting the IAB.

(Case #1): Alignment of DL transmission timing between IAB node and IAB donor

(Case #2): Alignment of DL and UL transmission timings at IAB node

(Case #3): Alignment of DL and UL reception timings at IAB node

(Case #4): Transmission by Case #2 and reception by Case #3 at IAB node

(Case #5): Application of Case #1 to access link timing and application of Case #4 to backhaul link timing at IAB node in different time slots

(Case #6): Alignment of DL transmission timing for Case #1+alignment of UL transmission timing for Case #2

(Case #7): Alignment of DL transmission timing for Case #1+alignment of UL reception timing for Case #3

In 3GPP Release 16, as described above, in order to match the DL transmission timing of the DU between the radio communication nodes constituting the IAB, it is agreed that the IAB node uses the calculating formula (TA/2+T_delta) to calculate the propagation delay (T_{propagation_0}) of the path (0) with the parent node and transmits the transmission timing as offset.

Here, TA is a value of Timing Advance for determining the transmission timing of the UE specified in 3GPP Release 15, and T_delta is determined considering the switching time from reception to transmission of the parent node.

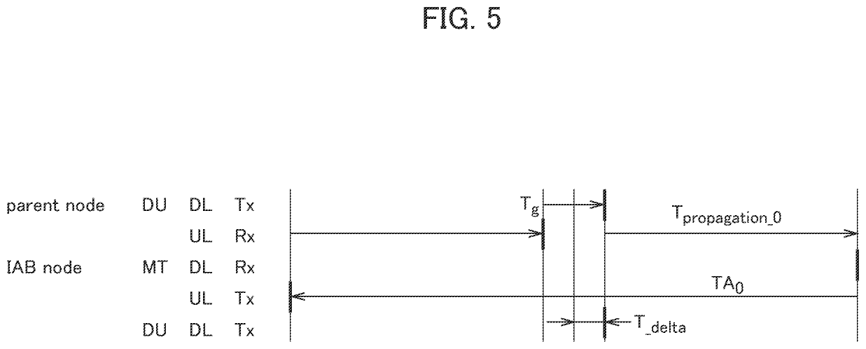

FIG. 5: is a diagram illustrating an example of a relationship of T_{propagation_0}, TA, and T_delta. As illustrated in FIG. 5, T_{propagation_0} is a value obtained by adding T_delta to a value obtained by halving TAO between the parent node and the IAB node. T_delta may correspond to a value obtained by having a gap (Tg) accompanying the switching time from UL reception to DL transmission at the parent node.

In the following, the operation associated with the DL and UL transmission timings when the radio communication node constituting the IAB supports Case #6 in addition to Case #1 will be described. In the case of supporting Case #6, in addition to Case #1, the UL transmission timing of the MT is also matched with the DL transmission timing of the IAB node and the child node DU.

The following contents may be assumed as a premise of an operation example described below.
Due to the limitation of half-duplex, one of TDM/SDM/FDM is applied to the backhaul link and the access link of the IAB node. In the case of the SDM or the FDM, the DU and the MT can be transmitted or received at the same time.
In the case of supporting SDM/FDM using a single panel, it is necessary to support Case #6 for simultaneous transmission at the IAB node, or it is necessary to support Case #7 for simultaneous reception at the IAB node.
Case #1 is supported in both transmission timings of the backhaul link and the access link.
Case #7 is supported only when compatible with the UE of Release 15.
The IAB node has to configure the DL transmission timing earlier than the DL reception timing by TA/2+T_delta.
T_delta is notified from the parent node. The value of T_delta takes into account factors such as the switching time from transmission to reception (or vice versa) and the offset between DL transmission and UL reception of the parent node due to factors such as hardware failure.
TA is derived based on the regulations of Release 15. TA is interpreted as a timing gap between the UL transmission timing and the DL reception timing.
In order to align the DL transmission timing of the IAB node by configuring the DL transmission timing (TA/2+T_delta) of the IAB node before the DL reception timing, T_delta needs to be configured to (−½) of the time interval between the start of the UL reception frame i of the IAB node and the start of the DL transmission frame i at the parent node.

Also, the following contents may be assumed regarding the timing alignment of Case #7.
An effective negative TA and TDM is introduced between the IAB node/UE that supports the new TA value and the child IAB node/UE that does not support the new TA value.
In order to enable the timing alignment of DL reception and UL reception at the IAB node, the following operations may be performed.
(Alt. 1): The negative time alignment (TA) of the IAB node that is applied to the child node of the IAB node is introduced.
(Alt. 2): The alignment of symbols (OFDM symbols) is enabled between DL reception and UL reception at the IAB node, but a positive TA that does not enable slot alignment is applied.
(Alt. 3): Relative offset signaling for the latest negative TA value applied to the child node of the IAB node is performed.

In the following, the operation example of timing alignment of Case #7 assuming (Alt. 1) or (Alt. 3) will be described.

### (3.2) Operation Example

In the operation example described below, Over-the-Air (OTA) synchronization of Case #7 (combination of Case #1 and Case #3) described above is realized between the radio communication nodes constituting the IAB.

### (3.2.1) Operation Overview

The following operations may be performed regarding notification of timing information and timing related information based on Case #3 (matching timings of DL reception of parent node MT and UL reception of DU).
(Operation Example 1): Negative value is introduced into TA of MAC RAR.
(Operation Example 1-1): Information (which may be 1 bit) indicating positive (+) or negative (−) is added to TA in MAC RAR.
(Operation Example 1-2): NTA value of MAC RAR is extended.

In 3GPP Release-15 (hereinafter Release-15), 0, 1, 2, . . . , 3846 are used (only positive values), but 3847 to 4095 are added by using empty bits. A negative value is configured by subtracting the value from 3846.
(Operation Example 2): Offset value from TA value applied to Release-15 or Case #6 is introduced.

In this case, the TA value notified from the parent node to the IAB node may be any of the following values.
(Alt. 1): TA value of Release-15
(Alt. 2): TA value applied to Case #6
(Alt. 3): Both of TA values applied to Release-15 and Case #6 may be configurable.

It should be noted that the TA value applied to Case #6 may mean T_{progagation_0}, or may mean TA/2 or TA, as described above.

Also, in the case of the operation example 2, the notification of the offset value from the TA value may be any of the following values.
(Alt. 1): Following the Release-15 mechanism, an integer value is notified, and the offset value is calculated by using Tc or granularity.

It should be noted that Tc is a basic time unit for NR specified in 3GPP TS38.211.
(Alt. 2): Offset value is notified to IAB node (lower node).
(Operation Example 3): Regarding Case #1 (matching transmission timing of DU of parent node and DU of IAB node), the following operation may be performed.
(Operation Example 3-1): T_delta specified in 3GPP Release-16 (hereinafter Release-16) is used.

In this case, the code of T_delta may be different from the code of T_delta of Release-16 (T_delta may be half the switching interval between reception and transmission at the parent node).
(Operation Example 3-2): Timing matching mechanism specified in 3GPP Release-16 is used.
(Operation Example 4): When Case #1/Case #6/Case #7 are dynamically switched, which Case is applied is indicated.

Also, regarding the reception timing alignment in Case #7, the alignment at the symbol level or slot level is possible.

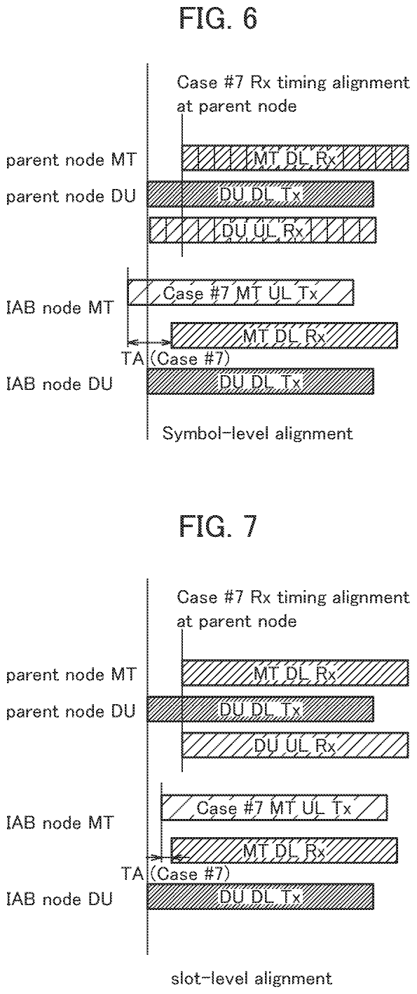

FIG. 6 illustrates an example of the symbol-level timing alignment at the parent node and the IAB node in Case #7. Also, FIG. 7 illustrates an example of the slot-level timing alignment at the parent node and the IAB node in Case #7. It should be noted that the symbol level may mean that an OFDM symbol transmitted and received between the radio communication nodes is used as a reference. Also, the slot level may mean that a slot configured by a predetermined number (for example, 14) of OFDM symbols and constituting part of a radio frame (or subframe) is used as a reference.

As illustrated in FIGS. 6 and 7, the slot-level reception timing alignment may achieve high resource utilization as compared to the symbol-level reception timing alignment, but It may cause a situation in which the negative TA is required in the IAB node.

Therefore, in the above-described operation example, when the slot-level timing alignment of Case #7 is supported by the parent node, the operations associated with signaling related to the alignment of the UL transmission timing of the MT at the IAB node and the alignment of the DL transmission timing of the DU at the IAB node is the main operation.

In order to support the slot-level timing alignment of Case #7 at the parent node, the IAB node needs to configure the UL transmission timing (TA=2Tp−T1) of the MT before the DL reception timing of the MT.

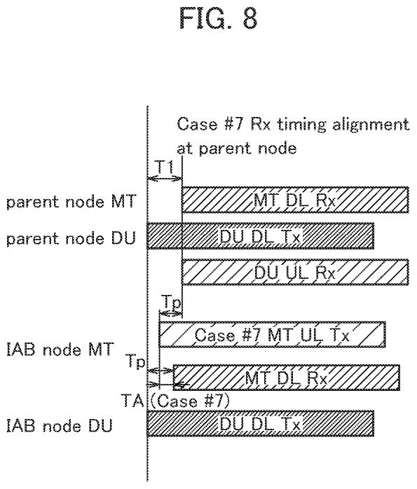

FIG. 8 illustrates an example of the slot-level timing alignment (including Tp and T1) at the parent node in Case #7.

Here, Tp may mean the propagation delay between the parent node and the IAB node, and T1 may mean the gap between the DL transmission timing of the DU and the DL reception timing of the MT at the parent node.

In this case, TA can be negative. As described above, the negative value can be introduced into the TA of the MAC RAR, or can be addressed by signaling the relative offset with respect to the negative TA value. In the following, the signaling operation for alignment of the UL transmission timing of the MT and the DL transmission timing of the DU at the IAB node will be described in more detail.

### (3.2.2) Operation Example 1

In this operation example, a negative initial TA is introduced into the MAC RAR in the alignment of the UL transmission timing of the MT at the IAB node. From the viewpoint of detailed signaling design of MAC RAR, specifically, the following operations may be performed.
(Operation Example 1-1): One bit is added to indicate negative or positive TA of MAC RAR.

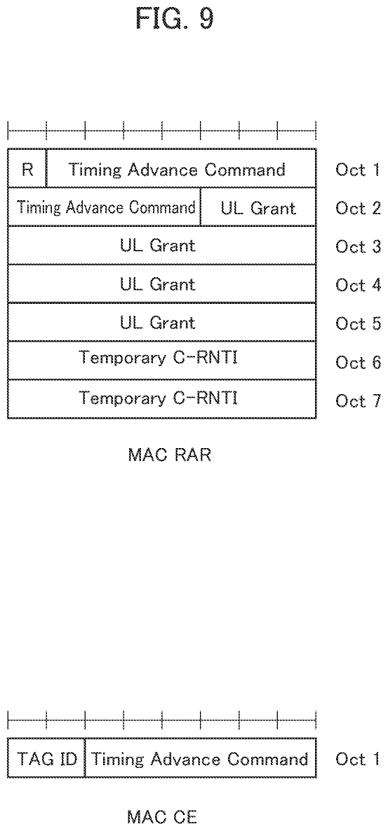

For example, reserved bits of MAC RAR specified in Release-15 can be used. FIG. 9 illustrates a configuration example of Random Access Response (RAR) and MAC-CE. As illustrated in FIG. 9, in Release 15, the UL frame number for transmission from the UE starts before the start of the corresponding DL frame in the UE.

A value (N_TA, offset) may be provided to the UE by RRC signaling, or the UE may determine a default value.

In the case of initial access, TA is indicated via TAC of RAR (NTA=TA·16·64/2μ TA=0, 1, 2, . . . , 3846). Also, in other cases, TA is also indicated via TAC of MAC CE.

(N_{TA_new}=N_{TA_old}+(T_{A}−31)·16·64/2^{μ}T_{A}=0,1,2, . . . ,63).
(Operation Example 1-2): Reserved value of TA of MAC RAR is used.

Specifically, the negative TA can be indicated by using reserved values (3847 to 4095) of TA (NTA=TA·16·64/2μ TA=0, 1, 2, . . . , 3846) specified in Release-15.

It should be noted that, considering that the number of reserved values is limited, a larger granularity than the TA of Release 15 may be applied to the negative TA. For example, granularity may be applied as follows.

N_{TA_negative}=(3846−T_{A_negative})*granularity,T_{A_negative}=3847,3848,3849, . . . ,4095 [Math. 1]

More specifically, in order to achieve the same range as the TA specified in Release-15, the granularity may be about 15 times the granularity of the TA of Release-15.

### (3.2.3) Operation Example 2

In this operation example, the offset value indicating the relative offset with respect to the negative TA value is notified in the alignment of the UL transmission timing of the MT at the IAB node. That is, when the timing alignment of Case #7 is supported by the parent node, the IAB node may configure the UL transmission timing (TA-Toffset) of the MT before the DL reception timing.

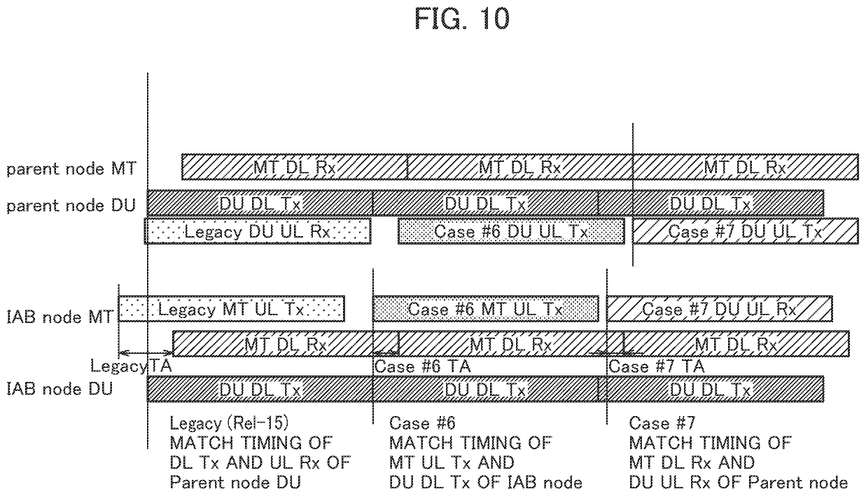

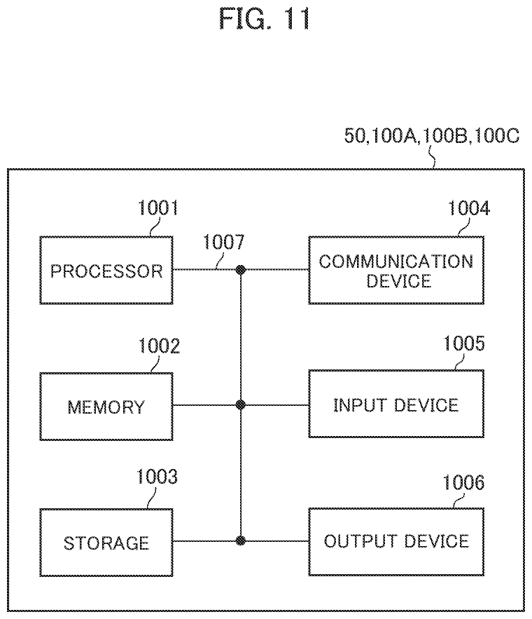

FIG. 10 illustrates an example of the timing alignment at the parent node and the IAB node according to 3GPP Release-15 (Legacy), Case #6, and Case #7.

As illustrated in FIG. 10, in the radio communication system 10, since different timing alignments can be performed, the TA value may be notified as follows.
(Alt. 1): TA_{CASE #7}=TA_{legacy}−Toffset
(Alt. 2): TA_{CASE #7}=TA_{case #6}−Toffset
(Alt. 3): Configuration is performed to indicate whether Toffset is associated with Release-15 (legacy) or Case #6 It should be noted that the default operation may be defined by TACASE #7=TAlegacy−Toffset, as in Alt. 1.

Also, Toffset may be notified via MAC CE or RRC signaling. Toffset may be indicated as follows.
(Alt. 1): Similar to Release-15 TA mechanism, the initial Toffset is shown, and the gap between Toffset_new and Toffset_old is shown so as to update Toffset.

For example, the initial Toffset is expressed as

N_{Toffset}*T_{c},N_{Toffset}=T_{Toffset}*granularity,T_{Toffset}=0,1,2, . . . ,k [Math. 2]

It may be notified by MAC CE or RRC signaling. It should be noted that the granularity may be the same as TA of Release-15.

The update of Toffset is expressed as

Toffset=N_{Toffset}*T_{c},N_{Toffset_new}=N_{Toffset_old}+(T_{Toffset}−k)*granularity [Math. 3]

It may be notified by MAC CE or RRC signaling. Here, k may indicate the range of each update, and the granularity may be the same as TA of Release-15.
(Alt. 2): The offset value is directly indicated.

Toffset=N_{Toffset}*T_{c},N_{Toffset}=T_{Toffset}*granularity [Math. 4]

Also in this case, Toffset may be notified by MAC CE or RRC signaling.

### (3.2.4) Operation Example 3

In this operation example, in order to realize Case #1 (the transmission timings of the DU of the parent node and the DU of the IAB node are matched), the timing matching mechanism specified in 3GPP Release-16 or T_delta is used.

Specifically, in the case of the DL transmission timing alignment of the DU of all related IAB nodes, the Release-16 mechanism may be followed, or the UL transmission timing aligning method of the MT in Case #6 described above may be applied.

Alternatively, the DL transmission timing alignment of the DU of the IAB node may use the UL transmission timing of the MT in Case #7 as reference. As illustrated in FIG. 8, the IAB node may configure the DL transmission timing of the DU before the DL transmission timing ((½)*TACase #7+(½)*T1) of the MT.

Also, in Release-16, the IAB node may configure the DL transmission timing (TA/2+T_delta) of the DU before the DL reception timing of the MT at the parent node, and T_delta may be configured as (−½) of the timing interval between the DL transmission timing of the DU and the UL reception timing of the DU at the parent node.

In this operation example, the UL transmission timing of Case #7 is used as a reference and the DL transmission timing of the DU is shown. Therefore, the following operation may be performed.
(Operation Example 3-1): Reuse T_delta of Release-16 and define the operation of different IAB node as Release-16

That is, the IAB node configures the DL transmission timing ((½)*TACase #7−T_delta) of the DU before the DL reception timing of the MT. T_delta may be configured as (−½) of the timing interval between the DL transmission timing of the DU and the UL reception timing of the actual DU, based on the UL transmission timing of the MT of the parent node in Case #7.
(Operation Example 3-2): The operation of the IAB node in accordance with Release-16 is reused and different instructions of T1 are defined.

In this case, the IAB node may configure the DL transmission timing ((½)*TACase #7−T1) of the DU before the DL reception timing of the MT. T1 may be configured as (−½) of the timing interval between the DL transmission timing of the DU and the UL reception timing of the actual DU, based on the UL transmission timing of the MT of the parent node in Case #7. That is, in this case, T1 may be appropriately configured in a meaning different from the specified contents of T_delta of Release-16 (gap between the DL transmission timing of the DU and the DL reception timing of the MT at the parent node). Furthermore, in this case, T1 may be determined without depending on the implementation (capability) of the radio communication node such as the parent node.

### (3.2.5) Operation Example 4

In this operation example, when Case #1/Case #6/Case #7 are dynamically switched, which Case is applied is explicitly or implicitly indicated from the parent node (or the CU 50) to the IAB node (or the child node).

As described above, in the radio communication system 10, Case #1/Case #6/Case #7 may be dynamically switched. In such a case, the operation associated with the timing alignment described above may be dynamically switched according to the applied Case.
(Operation Example 4-1): Whether the timing alignment according to Case #1, Case #6, or Case #7 is applied is explicitly indicated by downlink control information, for example, UL scheduling grant DCI.
(Operation Example 4-2): Whether the timing alignment according to Case #1, Case #6, or Case #7 is applied is determined by whether simultaneous transmission is performed by using a specific radio resource.

Specifically, when the simultaneous transmission of the DU and the MT is performed, the UL transmission timing alignment according to Case #7 (or Case #6) is applied; otherwise, it may be determined (assumed) that the UL transmission timing alignment according to Case #1 is applied.

### (4) Operation and Effect

According to the above-described embodiment, the following effects can be obtained. Specifically, the radio communication node 100A (parent node) can determine the alignment value (negative TA) of the UL reception timing based on the timing information (TA) used for determining the UL transmission timing, or the offset value from the TA, and can transmit the determined alignment value or offset value to the radio communication node 100B (lower node).

Therefore, even when Case #7 is supported, the IAB node can perform the timing alignment based on the alignment value or the offset value and can match the DL and UL reception timings at the IAB node in addition to Case #1. That is, according to the radio communication system 10, the transmission timing and the reception timing of the DU and MT can be reliably matched in the IAB.

In the present embodiment, for example, the radio communication node 100B (LAB node) can align the DL transmission timing of the upper node and the DL transmission timing of the radio communication node 100B based on the time (T_delta) associated with the switching from UL reception to DL transmission.

Therefore, even when Case #7 is supported, the operation according to Case #1, specifically, the transmission timings of the DU of the parent node and the DU of the IAB node can be more reliably matched.

In the present embodiment, when the timing according to Case #7 is aligned, the radio communication node 100B (IAB node) can implicitly determine the aligning method of the DL transmission timing and the UL reception timing, based on the downlink control information (DCI) from the upper node or the DL transmission timing and UL reception timing.

Therefore, even when the Case #1/Case #6/Case #7 are dynamically switched, the DL transmission timing and the UL reception timing can be more reliably matched.

### (5) Other Embodiments

Although the contents of the present invention have been described with reference to the embodiments, the present invention is not limited to these descriptions, and it will be obvious to those skilled in the art that various modifications and improvements can be made thereto.

For example, in the above-described embodiments, the names of the parent node, the IAB node, and the child node are used, these names may change as long as the configuration of the radio communication node in which the radio backhaul between the radio communication nodes such as gNB and the radio access with the UE are integrated is adopted. For example, the names may be simply called a first node, a second node, or the like, or may be called an upper node, a lower node or a relay node, an intermediate node, or the like.

Also, the radio communication node may be simply called a communication device or a communication node, or may be read as a radio base station.

In the above-described embodiments, the terms “downlink (DL)” and “uplink (UL)” are used, but may be called by other terms. For example, the terms may be replaced or associated with the terms such as forward link, reverse link, access link, and backhaul. Alternatively, the terms such as a first link, a second link, a first direction, and a second direction may be simply used.

Furthermore, the block configuration diagrams (FIGS. 3 and 4) used to describe the above-described embodiments illustrate blocks of functional units. Those functional blocks (structural components) can be realized by a desired combination of at least one of hardware and software. A realization method for each functional block is not particularly limited. That is, each functional block may be realized by one device combined physically or logically. Alternatively, two or more devices separated physically or logically may be directly or indirectly connected (for example, wired, or wireless) to each other, and each functional block may be realized by these plural devices. The functional blocks may be realized by combining software with the one device or the plural devices mentioned above.

Functions include judging, determining, determining, calculating, computing, processing, deriving, investigating, searching, confirming, receiving, transmitting, outputting, accessing, resolving, selecting, choosing, establishing, comparing, assuming, expecting, considering, broadcasting, notifying, communicating, forwarding, configuring, reconfiguring, allocating (mapping), assigning, and the like. For example, a functional block (structural component) that causes transmitting may be called a transmitting unit or a transmitter. For any of the above, as explained above, the realization method is not particularly limited to any one method.

Furthermore, the CU 50 and the radio communication nodes 100A to 100C described above can function as a computer that performs the processing of the radio communication method of the present disclosure. FIG. 13 is a diagram illustrating an example of a hardware configuration of the device. As illustrated in FIG. 13, the device can be configured as a computer device including a processor 1001, a memory 1002, a storage 1003, a communication device 1004, an input device 1005, an output device 1006, a bus 1007, and the like.

Furthermore, in the following explanation, the term “device” can be replaced with a circuit, device, unit, and the like. Hardware configuration of the device can be constituted by including one or plurality of the devices illustrated in the figure, or can be constituted by without including a part of the devices.

The functional blocks of the device (see FIGS. 3 and 4) can be realized by any of hardware elements of the computer device or a combination of the hardware elements.

Moreover, the processor 1001 performs computing by loading a predetermined software (program) on hardware such as the processor 1001 and the memory 1002, and realizes various functions of the device by controlling communication via the communication device 1004, and controlling reading and/or writing of data on the memory 1002 and the storage 1003.

The processor 1001, for example, operates an operating system to control the entire computer. The processor 1001 can be configured with a central processing unit (CPU) including an interface with a peripheral device, a control device, a computing device, a register, and the like.

Moreover, the processor 1001 reads a program (program code), a software module, data, and the like from the storage 1003 and/or the communication device 1004 into the memory 1002, and executes various processes according to the data. As the program, a program that is capable of executing on the computer at least a part of the operation explained in the above embodiments is used. Alternatively, various processes explained above can be executed by one processor 1001 or can be executed simultaneously or sequentially by two or more processors 1001. The processor 1001 can be implemented by using one or more chips. Alternatively, the program can be transmitted from a network via a telecommunication line.

The memory 1002 is a computer readable recording medium and is configured, for example, with at least one of Read Only Memory (ROM), Erasable Programmable ROM (EPROM), Electrically Erasable Programmable ROM (EEPROM), Random Access Memory (RAM), and the like. The memory 1002 can be called register, cache, main memory (main storage device), and the like. The memory 1002 can store therein a program (program codes), software modules, and the like that can execute the method according to the embodiment of the present disclosure.

The storage 1003 is a computer readable recording medium. Examples of the storage 1003 include an optical disk such as Compact Disc ROM (CD-ROM), a hard disk drive, a flexible disk, a magneto-optical disk (for example, a compact disk, a digital versatile disk, Blu-ray (Registered Trademark) disk), a smart card, a flash memory (for example, a card, a stick, a key drive), a floppy (Registered Trademark) disk, a magnetic strip, and the like. The storage 1003 can be called an auxiliary storage device. The recording medium can be, for example, a database including the memory 1002 and/or the storage 1003, a server, or other appropriate medium.

The communication device 1004 is hardware (transmission/reception device) capable of performing communication between computers via a wired and/or wireless network. The communication device 1004 is also called, for example, a network device, a network controller, a network card, a communication module, and the like.

The communication device 1004 includes a high-frequency switch, a duplexer, a filter, a frequency synthesizer, and the like in order to realize, for example, at least one of Frequency Division Duplex (FDD) and Time Division Duplex (TDD).

The input device 1005 is an input device (for example, a keyboard, a mouse, a microphone, a switch, a button, a sensor, and the like) that accepts input from the outside. The output device 1006 is an output device (for example, a display, a speaker, an LED lamp, and the like) that outputs data to the outside. Note that, the input device 1005 and the output device 1006 may be integrated (for example, a touch screen).

In addition, the respective devices, such as the processor 1001 and the memory 1002, are connected to each other with the bus 1007 for communicating information thereamong. The bus 1007 may be configured by using a single bus or may be configured by using different buses for each device.

Further, the device is configured to include hardware such as a microprocessor, a digital signal processor (Digital Signal Processor: DSP), Application Specific Integrated Circuit (ASIC), Programmable Logic Device (PLD), and Field Programmable Gate Array (FPGA). Some or all of these functional blocks may be realized by the hardware. For example, the processor 1001 may be implemented by using at least one of these hardware.

Notification of information is not limited to that explained in the above aspect/embodiment, and may be performed by using a different method. For example, the notification of information may be performed by physical layer signaling (for example, Downlink Control Information (DCI), Uplink Control Information (UCI), upper layer signaling (for example, RRC signaling, Medium Access Control (MAC) signaling, broadcast information (Master Information Block (MIB), System Information Block (SIB)), other signals, or a combination of these. The RRC signaling may be called RRC message, for example, or can be RRC Connection Setup message, RRC Connection Reconfiguration message, or the like.

Each aspect/embodiment described in the present disclosure may be applied to at least one of Long Term Evolution (LTE), LTE-Advanced (LTE-A), SUPER 3G, IMT-Advanced, 4th generation mobile communication system (4G), 5th generation mobile communication system (5G), Future Radio Access (FRA), New Radio (NR), W-CDMA (registered trademark), GSM (registered trademark), CDMA2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems using other appropriate systems, and next-generation systems extended based on them. Further, a plurality of systems may be combined (for example, a combination of at least one of the LTE and the LTE-A with the 5G).

As long as there is no inconsistency, the order of processing procedures, sequences, flowcharts, and the like of each of the above aspects/embodiments in the present disclosure may be exchanged. For example, the various steps and the sequence of the steps of the methods explained above are exemplary and are not limited to the specific order mentioned above.

The specific operation that is performed by the base station in the present disclosure may be performed by its upper node in some cases. In a network constituted by one or more network nodes having a base station, the various operations performed for communication with the terminal may be performed by at least one of the base station and other network nodes other than the base station (for example, MME, S-GW, and the like may be considered, but not limited thereto). In the above, an example in which there is one network node other than the base station is explained; however, a combination of a plurality of other network nodes (for example, MME and S-GW) may be used.

Information and signals (information and the like) can be output from an upper layer (or lower layer) to a lower layer (or upper layer). It may be input and output via a plurality of network nodes.

The input/output information can be stored in a specific location (for example, a memory) or can be managed in a management table. The information to be input/output can be overwritten, updated, or added. The information can be deleted after outputting. The inputted information can be transmitted to another device.

The determination may be made by a value (0 or 1) represented by one bit or by Boolean value (Boolean: true or false), or by comparison of numerical values (for example, comparison with a predetermined value).

Each aspect/embodiment described in the present disclosure may be used separately or in combination, or may be switched in accordance with the execution. In addition, notification of predetermined information (for example, notification of “being X”) is not limited to being performed explicitly, it may be performed implicitly (for example, without notifying the predetermined information).

Instead of being referred to as software, firmware, middleware, microcode, hardware description language, or some other name, software should be interpreted broadly to mean instruction, instruction set, code, code segment, program code, program, subprogram, software module, application, software application, software package, routine, subroutine, object, executable file, execution thread, procedure, function, and the like.

Further, software, instruction, information, and the like may be transmitted and received via a transmission medium. For example, when a software is transmitted from a website, a server, or some other remote source by using at least one of a wired technology (coaxial cable, fiber optic cable, twisted pair, Digital Subscriber Line (DSL), or the like) and a wireless technology (infrared light, microwave, or the like), then at least one of these wired and wireless technologies is included within the definition of the transmission medium.

Information, signals, or the like mentioned above may be represented by using any of a variety of different technologies. For example, data, instruction, command, information, signal, bit, symbol, chip, or the like that may be mentioned throughout the above description may be represented by voltage, current, electromagnetic wave, magnetic field or magnetic particle, optical field or photons, or a desired combination thereof.

It should be noted that the terms described in this disclosure and terms necessary for understanding the present disclosure may be replaced by terms having the same or similar meanings. For example, at least one of a channel and a symbol may be a signal (signaling). Also, a signal may be a message. Further, a component carrier (Component Carrier: CC) may be referred to as a carrier frequency, a cell, a frequency carrier, or the like.

The terms “system” and “network” used in the present disclosure can be used interchangeably.

Furthermore, the information, the parameter, and the like explained in the present disclosure can be represented by an absolute value, can be expressed as a relative value from a predetermined value, or can be represented by corresponding other information. For example, the radio resource can be indicated by an index.

The name used for the above parameter is not a restrictive name in any respect. In addition, formulas and the like using these parameters may be different from those explicitly disclosed in the present disclosure. Because the various channels (for example, PUCCH, PDCCH, or the like) and information element can be identified by any suitable name, the various names assigned to these various channels and information elements shall not be restricted in any way.

In the present disclosure, it is assumed that “base station (Base Station: BS)”, “radio base station”, “fixed station”, “NodeB”, “eNodeB (eNB)”, “gNodeB (gNB)”, “access point”, “transmission point”, “reception point”, “transmission/reception point”, “cell”, “sector”, “cell group”, “carrier”, “component carrier”, and the like can be used interchangeably. The base station may also be referred to with the terms such as a macro cell, a small cell, a femtocell, or a pico cell.

The base station can accommodate one or more (for example, three) cells (also called sectors). In a configuration in which the base station accommodates a plurality of cells, the entire coverage area of the base station can be divided into a plurality of smaller areas. In each such a smaller area, communication service can be provided by a base station subsystem (for example, a small base station for indoor use (Remote Radio Head: RRH)).

The term “cell” or “sector” refers to a part or all of the coverage area of a base station and/or a base station subsystem that performs communication service in this coverage.

In the present disclosure, the terms “mobile station (Mobile Station: MS)”, “user terminal”, “user equipment (User Equipment: UE)”, “terminal” and the like can be used interchangeably.

The mobile station is called by the persons skilled in the art as a subscriber station, a mobile unit, a subscriber unit, a radio unit, a remote unit, a mobile device, a radio device, a radio communication device, a remote device, a mobile subscriber station, an access terminal, a mobile terminal, a radio terminal, a remote terminal, a handset, a user agent, a mobile client, a client, or with some other suitable term.

At least one of a base station and a mobile station may be called a transmitting device, a receiving device, a communication device, or the like. Note that, at least one of a base station and a mobile station may be a device mounted on a moving body, a moving body itself, or the like. The moving body may be a vehicle (for example, a car, an airplane, or the like), a moving body that moves unmanned (for example, a drone, an automatically driven vehicle, or the like), a robot (manned type or unmanned type). At least one of a base station and a mobile station can be a device that does not necessarily move during the communication operation. For example, at least one of a base station and a mobile station may be an Internet of Things (IoT) device such as a sensor.

Also, a base station in the present disclosure may be read as a mobile station (user terminal, hereinafter the same). For example, each of the aspects/embodiments of the present disclosure may be applied to a configuration that allows a communication between a base station and a mobile station to be replaced with a communication between a plurality of mobile stations (for example, may be referred to as Device-to-Device (D2D), Vehicle-to-Everything (V2X), or the like). In this case, the mobile station may have the function of the base station. Words such as “uplink” and “downlink” may also be replaced with wording corresponding to inter-terminal communication (for example, “side”). For example, terms an uplink channel, a downlink channel, or the like may be read as a side channel.

Likewise, a mobile station in the present disclosure may be read as a base station. In this case, the base station may have the function of the mobile station.

The radio frame may include one or more frames in the time domain. Each of one or more frames in the time domain may be called a subframe.

The subframe may also include one or more slots in the time domain. The subframe may have a fixed time length (for example, 1 ms) that does not depend on numerology.

The numerology may be a communication parameter applied to transmission and/or reception of a certain signal or channel. The numerology may indicate, for example, at least one of subcarrier spacing (SCS), bandwidth, symbol length, cyclic prefix length, transmission time interval (TTI), number of symbols per TTI, radio frame configuration, specific filtering processing performed by the transceiver in the frequency domain, and specific windowing processing performed by the transceiver in the time domain.

The slot may include one or more symbols (Orthogonal Frequency Division Multiplexing (OFDM) symbols, Single Carrier Frequency Division Multiple Access (SC-FDMA) symbols or the like) in the time domain. The slot may be the time unit based on the numerology.

The slot may include a plurality of minislots. Each minislot may include one or more symbols in the time domain. The minislot may also be called a subslot. The minislot may include fewer symbols than the slot. The PDSCH (or PUSCH) transmitted in the time unit larger than the minislot may be called PDSCH (or PUSCH) mapping type A. The PDSCH (or PUSCH) transmitted by using the minislot may be called PDSCH (or PUSCH) mapping type B.

The radio frame, the subframe, the slot, the minislot, and the symbol all represent the time unit for signal transmission. The radio frame, the subframe, the slot, the minislot, and the symbol may have different names corresponding thereto.

For example, one subframe may be called the transmission time interval (TTI), the plurality of consecutive subframes may be called the TTI, and one slot or one minislot may be called the TTI. That is, at least one of the subframe and the TTI may be a subframe (1 ms) in the existing LTE, may be shorter than 1 ms (for example, 1-13 symbols), and may be longer than 1 ms. It should be noted that the unit indicating the TTI may be called the slot, the minislot, or the like, instead of the subframe.

Here, the TTI refers to, for example, the minimum time unit of scheduling in the radio communication. For example, in the LTE system, the base station performs scheduling for allocating radio resources (frequency band width usable in each UE, transmission power, or the like) to each UE in the units of TTI. The definition of the TTI is not limited thereto.

The TTI may be a transmission time unit of a channel-encoded data packet (transport block), a code block, a codeword, or the like, or may be a processing unit such as scheduling or link adaptation. It should be noted that, when the TTI is given, the time interval (for example, the number of symbols) in which the transport block, code block, codeword, or the like are actually mapped may be shorter than that of the TTI.

It should be noted that, when one slot or one minislot is called the TTI, one or more TTIs (that is, one or more slots or one or more minislots) may be the minimum time unit of scheduling. Also, the number of slots (number of minislots) that constitutes the minimum time unit of the scheduling may be controlled.

The TTI having a time length of 1 ms may be called normal TTI (TTI in LTE Rel. 8-12), normal TTI, long TTI, normal subframe, normal subframe, long subframe, slot, or the like. The TTI that is shorter than the normal TTI may be called shortened TTI, short TTI, partial TTI (or fractional TTI), shortened subframe, short subframe, minislot, subslot, slot, or the like.

It should be noted that long TTI (for example, normal TTI, subframe, or the like) may be replaced with a TTI having a time length exceeding 1 ms, and the short TTI (for example, shortened TTI) may be read as a TTI having a TTI length that is less than the long TTI length and greater than or equal to 1 ms.

The resource block (RB) is a resource allocation unit in the time domain and the frequency domain, and may include one or more consecutive subcarriers in the frequency domain. The number of subcarriers included in the RB may be the same regardless of the numerology and may be, for example, 12. The number of subcarriers included in the RB may be determined based on the numerology.

Also, the time domain of the RB may include one or more symbols and may have a length of one slot, one minislot, one subframe, or one TTI. One TTI, one subframe, or the like may include one or more resource blocks.

It should be noted that one or more RBs may be called a physical resource block (Physical RB: PRB), a subcarrier group (Sub-Carrier Group: SCG), a resource element group (Resource Element Group: REG), a PRB pair, an RB pair, or the like.

Also, the resource block may include one or more resource elements (Resource Element: RE). For example, one RE may be a radio resource area of one subcarrier and one symbol.

The bandwidth part (BWP) (which may also be referred to as partial bandwidth) may indicate a subset of continuous common RBs (common resource blocks) for a certain numerology in a certain carrier. Here, the common RB may be specified by the index of the RB based on the common reference point of the carrier. The PRB may be defined in the BWP and may be numbered in the BWP.

The BWP may include a BWP for UL (UL BWP) and a BWP for DL (DL BWP). One or more BWPs may be configured in one carrier for the UE.

At least one of the configured BWPs may be active, and the UE may not expect to transmit or receive certain signals/channels outside the active BWP. It should be noted that “cell”, “carrier”, or the like in the present disclosure may be read as “BWP”.

The structures of the radio frame, the subframe, the slot, the minislot, the symbol, and the like described above are merely examples. For example, the configurations such as the number of subframes included in the radio frame, the number of slots per subframe or radio frame, the number of minislots included in the slot, the number of symbols and RBs included in the slot or minislot, the number of subcarriers included in the RB, and the number of symbols in the TTI, the symbol length, and the cyclic prefix (CP) length can be variously changed.

The terms “connected”, “coupled”, or any variations thereof, mean any direct or indirect connection or coupling between two or more elements. Also, one or more intermediate elements may be present between two elements that are “connected” or “coupled” to each other. The coupling or connection between the elements may be physical, logical, or a combination thereof. For example, “connection” may be read as “access”. In the present disclosure, two elements can be “connected” or “coupled” to each other by using one or more wires, cables, printed electrical connections, and as some non-limiting and non-exhaustive examples, by using electromagnetic energy having wavelengths in the radio frequency region, the microwave region and light (both visible and invisible) regions, and the like.

The reference signal may be abbreviated as Reference Signal (RS) and may be called pilot (Pilot) according to applicable standards.

As used in the present disclosure, the phrase “based on” does not mean “based only on” unless explicitly stated otherwise. In other words, the phrase “based on” means both “based only on” and “based at least on”.

The “means” in the configuration of each device may be replaced with “unit”, “circuit”, “device”, and the like.

Any reference to an element using a designation such as “first”, “second”, and the like used in the present disclosure generally does not limit the amount or order of those elements. Such designations can be used in the present disclosure as a convenient way to distinguish between two or more elements. Thus, the reference to the first and second elements does not imply that only two elements can be adopted, or that the first element must precede the second element in some or the other manner.

In the present disclosure, the used terms “include”, “including”, and variants thereof are intended to be inclusive in a manner similar to the term “comprising”. Furthermore, the term “or” used in the present disclosure is intended not to be an exclusive disjunction.

Throughout this disclosure, for example, during translation, if articles such as “a”, “an”, and “the” in English are added, in this disclosure, these articles shall include plurality of nouns following these articles.

The term “determining” and “determining” as used in the present disclosure may encompass various operations. The “determining” and the “determining” may include, for example, “determining” or “determining” of judging, calculating, computing, processing, deriving, investigating, looking up, search, inquiry (for example, searching in a table, a database, or another data structure), ascertaining, and the like. Also, the “determining” and the “determining” may include “determining” and “determining” of receiving (for example, receiving information), transmitting (for example, transmitting information), input, output, accessing (for example, access to data in the memory), and the like. Also, the “determining” and the “determining” may include “determining” and “determining” of resolving, selecting, choosing, establishing, comparing, and the like. That is, the “determining” and the “determining” may include “determining” and “determining” of operations. Also, the “determining (determining)” may be read as “assuming”, “expecting”, “considering,” and the like.

In the present disclosure, the term “A and B are different” may mean “A and B are different from each other”. It should be noted that the term may mean “A and B are each different from C”. Terms such as “leave”, “coupled”, or the like may also be interpreted in the same manner as “different”.

Although the present disclosure has been described in detail above, it will be obvious to those skilled in the art that the present disclosure is not limited to the embodiments described in this disclosure. The present disclosure can be implemented as modifications and variations without departing from the spirit and scope of the present disclosure as defined by the claims.

Therefore, the description of the present disclosure is for the purpose of illustration, and does not have any restrictive meaning to the present disclosure.

### REFERENCE SIGNS LIST

10 Radio communication system
50 CU
100A, 100B, 100C Radio communication node
110 Radio transmitting unit
120 Radio receiving unit
130 NW IF unit
140 Control unit
150 Timing related information transmitting unit
161 Radio transmitting unit
162 Radio receiving unit
165 Downlink control information receiving unit
170 Control unit
200 UE
1001 Processor
1002 Memory
1003 Storage
1004 Communication device
1005 Input device
1006 Output device
1007 Bus

1. A radio communication node comprising:
a control unit configured to, when a transmission timing of a downlink and a reception timing of an uplink at a lower node are aligned, determine an alignment value of the reception timing based on timing information used to determine transmission timing of the uplink, or an offset value from the timing information; and
a transmitting unit configured to transmit the alignment value or the offset value to the lower node.

2. The radio communication node according to claim 1, wherein the control unit is configured to align the transmission timing of the downlink at an upper node and the transmission timing of the downlink at the radio communication node, based on time for switching from reception of the uplink to transmission of the downlink.

3. A radio communication node comprising:
a control unit configured to, when a transmission timing of a downlink and a reception timing of an uplink at the radio communication node are aligned, determine an aligning method of the transmission timing of the downlink and the reception timing of the uplink, based on downlink control information from an upper node, or the transmission timing of the downlink and the reception timing of the uplink; and
a transceiving unit configured to receive the uplink from a lower node and transmit the downlink to the lower node, based on the determined aligning method.
